(19) United States
(12) Patent Application Publication
(10) Pub. No.: US 2008/0308504 A1
(43) Pub. Date: Dec. 18, 2008

(54) ELEMENT LOADING MECHANISM AND METHOD

(76) Inventors: Matthew J. Hallan, Minneapolis, MN (US); Jon E. Johnson, Plymouth, MN (US); Martin H. Peery, Bloomington, MN (US); Lance D. Johnson, Eden Prairie, MN (US)

Correspondence Address: The Dow Chemical Company, Intellectual Property Section, P.O. Box 1967, Midland, MI, 48641-1967, US

(21) Appl. No.: 11/872,214

(22) Filed: Oct. 15, 2007

Related U.S. Application Data
(60) Provisional application No. 60/874,452, filed on Dec. 12, 2006.

(51) Int. Cl. B01D 35/30

(52) U.S. Cl. 210/741; 210/235

(57) ABSTRACT

A loader for moving a filter element between loaded and unloaded positions with respect to a pressure vessel is provided. The loader includes a connection section associated with a loader section. The connection section is operative to be secured in coaxial alignment with the pressure vessel. The loader section is operative to receive a filter element and move the filter element between the loaded and unloaded positions. The loader section includes a cradle assembly for supporting a filter element and a carriage assembly operative to engage the filter element and move it between the loaded and unloaded positions.

This application claims the benefit of U.S. Provisional Application No. 60/874,452 filed Dec. 12, 2006.

### FIELD OF THE INVENTION

The present invention relates to a loader assembly and a method for loading and unloading filter elements into or out of a pressure vessel.

### BACKGROUND OF THE INVENTION

Pressure-driven fluid separation systems involve passing a fluid feed mixture across, for example a surface of a filter membrane or other structure adapted to act as a selective barrier. Such a barrier permits some components of the fluid feed mixture to pass through more readily than other components of said mixture.

Commercial fluid separation processes use, for example, hollow fiber and spiral wound membrane arrangements. Spiral wound membranes provide a large, relative to hollow fibers, membrane contact area while permitting use of a rather small overall containment or pressure vessel. In a typical manufacturing process, one forms each spiral wound membrane (a rolled laminar structure with two spaced-apart ends) by wrapping one or more sheets of membrane material around a central permeate tube containing holes for recovery of a permeate stream. Spacers or other devices can be used to establish and maintain feed-retentate channels through which the fluid feed mixture passes for separation into a retentate component and a permeate component, the latter passing through a membrane surface. Each end cap, one for each end of the rolled laminar structure or spiral wound membrane, typically has defined therein an inner aperture that fits over, and allows fluid communication with, an end of the permeate tube and includes an outer locking ring suitable for use in securing adjacent separation elements together. U.S. Pat. No. 6,632,356 to Hallan et al., the teachings of which are incorporated herein by reference, provides an example of such an end cap. A filter element nominally comprises a combination of such a spiral wound membrane and two end caps.

A current commercial fluid separation process employs nominally standard “eight (8) inch” filter elements. Such elements have a target diameter of, 8 inches (20.3 centimeters (cm)) and a target length of 40 inches (101.6 cm). In such a process, a single pressure vessel typically accommodates several of such elements connected in series. The nominally standard 8 inch filter elements have a size and weight that allows manual element loading into, and removal from, a pressure vessel.

Filter element manufacturers and users now seek larger elements and have general agreement upon a nominal sixteen (16) inch element that increases target diameter to 16 inches (40.6 cm), but maintains the target length at 40 inches (101.6 cm). The nominal 16 inch element weighs more that the nominal 8 inch element and leads to desire on the part of those who load filter elements into, or remove filter elements from, a pressure vessel for a mechanical loader.

An article entitled “Meeting the challenge of construction, operation and maintenance of large scale RO elements”, 2005©American Water Works-Membrane Tech. Conference, by Antonia von Gottberg and Rick Lesan (hereinafter referred to as “Gottberg”), discloses a mechanical loader. Gottberg places the loader on, but does not secure the loader to, a height-adjustable platform. Gottberg describes removal of end caps from each end of a pressure vessel to create an open tube and use of a rope and pulley system is used to pull filter elements from the loader into the pressure vessel after the loader is roughly coaxial with the open tube. Gottberg provides no description, teaching, or suggestion related to securing the loader to any portion of the pressure vessel or to a support structure associated with the pressure vessel.

Those who load elements into, or remove elements from, a pressure vessel seek one or more of a number of improvements to mechanical loaders such as that taught by Gottberg.

### SUMMARY OF THE INVENTION

A first embodiment of the present invention is a loader for moving a filter element from one to another of a loaded position and an unloaded position, each position being relative to an interior, element-receiving portion of a pressure vessel, the pressure vessel also having an exterior spaced apart from said interior so as to form a pressure vessel body, the pressure vessel body being secured in place by a support structure operatively connected to at least a surface portion of the pressure vessel exterior, the loader comprising a loader section and a connection section, the loader section having a section interconnect end, a distal end remote from the section interconnect end, and an element support structure, the element support structure spanning between, and being operatively connected to, each of the section interconnect and distal ends, the connection section having a pressure vessel insert end, a loader connect end, and a connecting guide structure, the connecting guide structure spanning between, and being operatively connected to, each of pressure vessel insert end and the loader connect end, the section interconnect end of the loader section and the loader connect end of the connection section being operatively connected one to another so as to provide an assembled loader, the assembled loader including at least one pressure vessel support structure connecting means, each pressure vessel support structure connecting means being proximate to the operative connection between the loader section and the connection section and operative to removably secure the assembled loader to at least a portion of at least one of a pressure vessel support structure or a pressure vessel.

A second embodiment of the present invention, there is provided a loader for moving a filter element between loaded and unloaded positions with respect to a pressure vessel. The pressure vessel is supported by a support structure. The loader comprises a cradle assembly operative to support a filter element. The loader further includes a carriage assembly moveable relative to the cradle assembly and operative to engage the filter element and move the filter element between loaded and unloaded positions. The loader further includes a drive system operatively connected to the carriage assembly to move the carriage assembly and thereby the filter element between the loaded and unloaded positions.

According to another embodiment of the present invention there is provided a method of loading a filter element into a pressure vessel having an inside and an outside. The pressure vessel is supported by a support structure. The pressure vessel has an opening for receiving a filter element. The method comprises releasably securing the loader to at least one of the pressure vessel and the support structure. The method further comprises moving a filter element between a loaded and an unloaded position.

### BRIEF DESCRIPTION OF THE DRAWINGS

The present invention will become more fully understood from the detailed description and the accompanying drawings, wherein:

FIG. 1 is a perspective view partially broken away showing one embodiment of a pressure vessel rack;

FIGS. 2A-2C illustrate several views of an embodiment of a loader;

FIG. 3 is a cross sectional view of a portion of a pressure vessel and a connection section of the loader of FIG. 2 in an unlocked position;

FIG. 4 is a perspective view of on embodiment of a clamping structure of the connection section of FIG. 3;

FIG. 5 is a perspective view of one embodiment of a draw ring of the connection section of FIG. 3;

FIGS. 6A-6B illustrate an embodiment for securely orienting a loader relative to a pressure vessel according to the present disclosure.

FIG. 7 illustrates an embodiment for attaching a loader to a pressure vessel using an external face mount approach according to the present disclosure.

### DETAILED DESCRIPTION OF THE PREFERRED EMBODIMENTS

Embodiments of the present disclosure will now be described in relation to the accompanying drawings, which will at least assist in illustrating the various features of the various embodiments. In the Figs, the first digit of a reference number refers to the Figure in which it is used, while the remaining two digits of the reference number refer to the same or equivalent parts of embodiment(s) of the present disclosure used throughout the several Figs of the drawings.

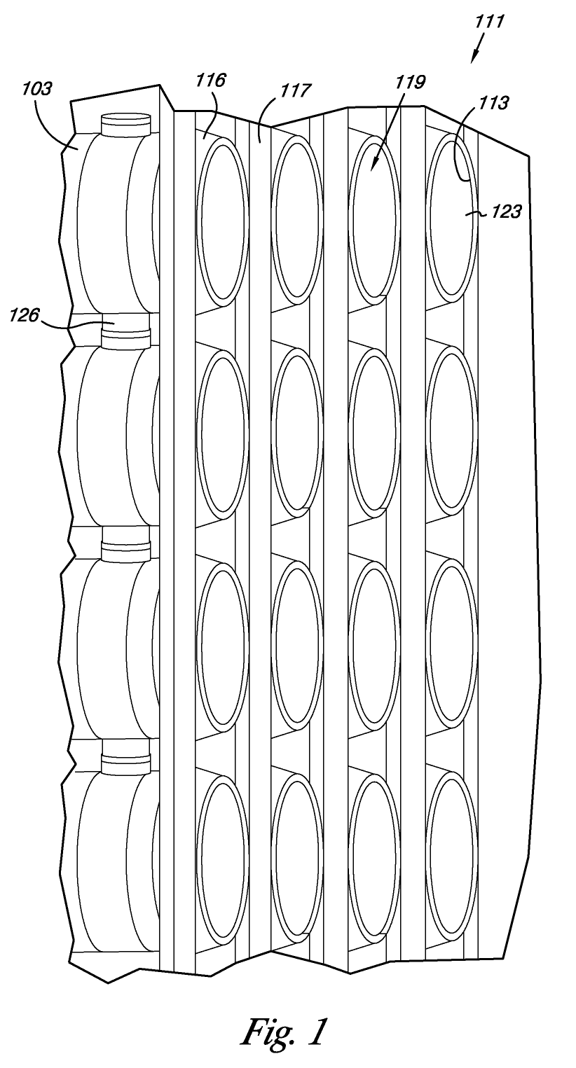

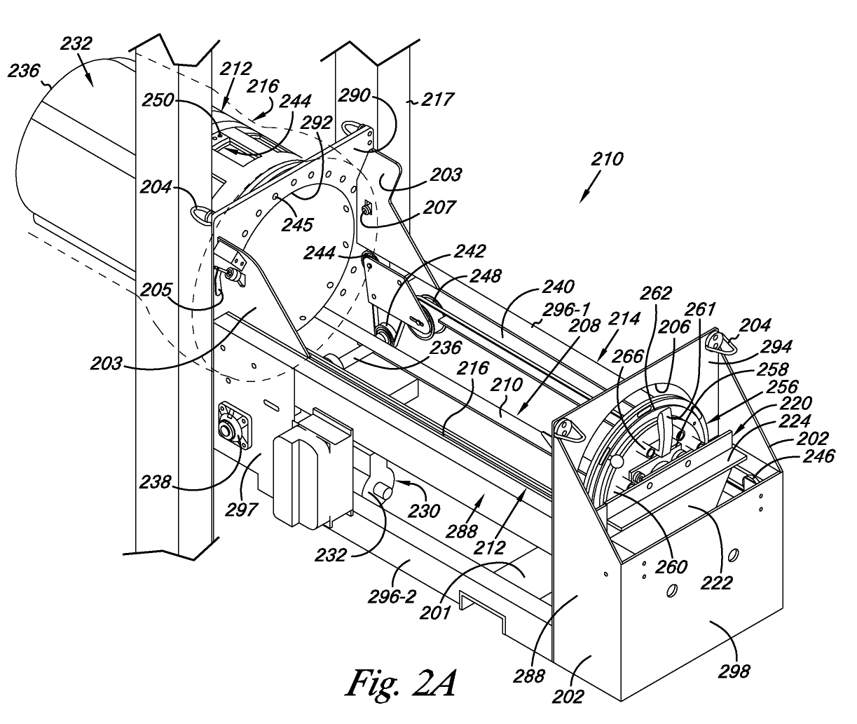

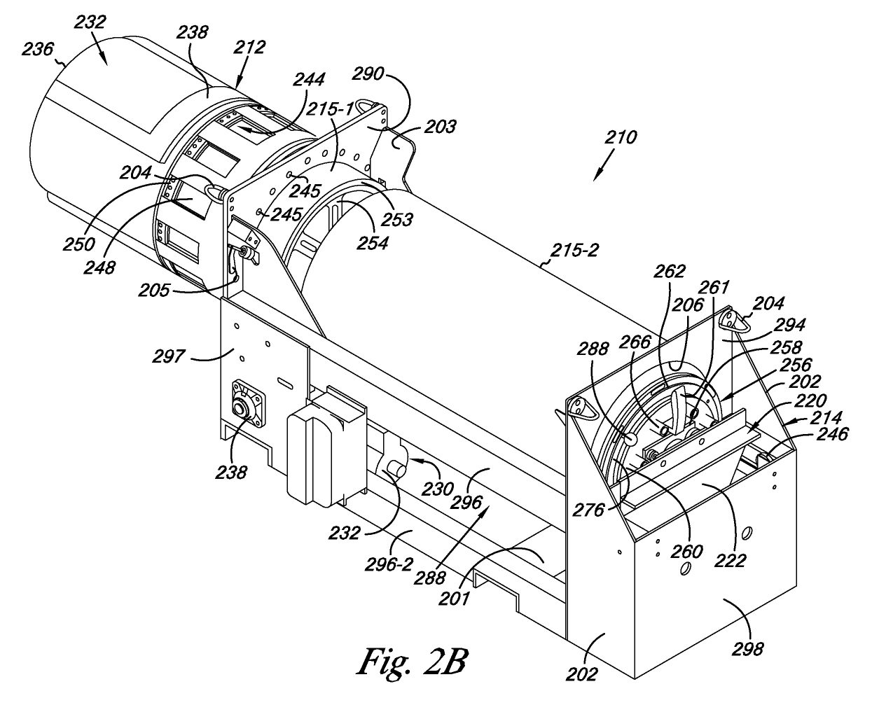

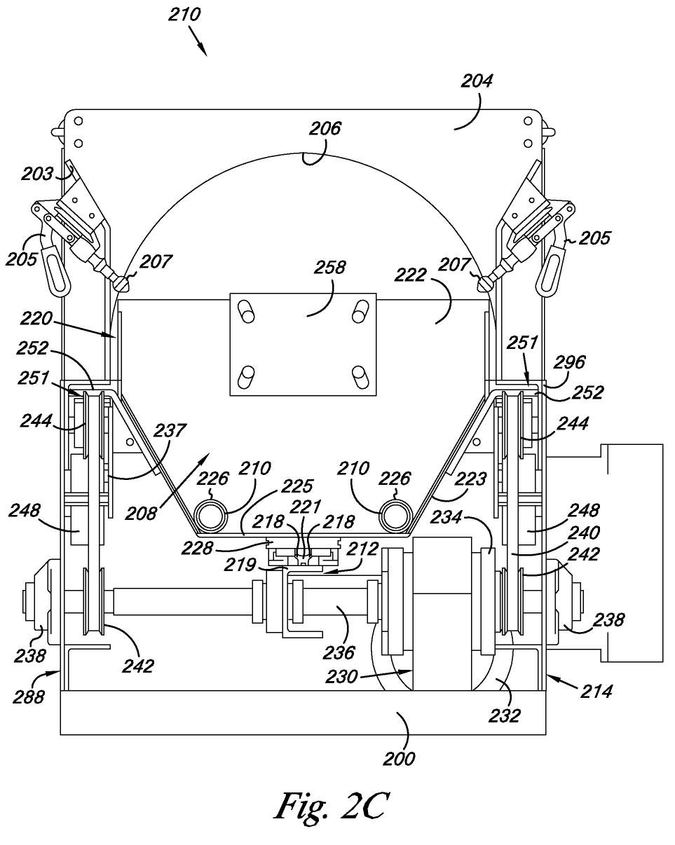

FIG. 1 shows one embodiment of a pressure vessel rack 111. Pressure vessel rack 111 comprises a support structure 117 and a plurality of pressure vessels 116. Each pressure vessel 116 has a first end 113, a second end (not shown), an inside 119 and an outside 103. Further, each pressure vessel defines an opening 123 through which a filter element (shown at 215 in FIG. 2B) may pass to be loaded into, desirably with a close-tolerance fit, a space defined by the inside 119 of pressure vessel 116 or unloaded from said space. Inlet/outlet ports 126 preferably extend between adjacent pressure vessels 116 to allow a feed mixture or feed to flow into a pressure vessel 116 or permeate to flow out of a pressure vessel 116, whichever is appropriate. Concentrate or reject ports (not shown) allow flow of retentate or contaminated material out of a pressure vessel 116.

FIGS. 2A-2C illustrates several views of an embodiment of a loader 210. As seen in FIG. 2, the loader primarily comprises two sections; a connection section generally indicated at 212 and a loader section generally indicated at 214. The loader 210 is adapted to be used to load a filter element (215 in FIG. 2B) into, or remove a filter element (sometimes referred to as a filter membrane, e.g. a spiral wound filter membrane as discussed above) 215 from a pressure vessel 216.

FIG. 2A provides a schematic illustration of an embodiment of a loader 210 wherein at least a portion of connection section 212 passes through opening 123 and into the inside 119 of a pressure vessel 116 shown above in FIG. 1. In FIG. 2A the pressure vessel 216 is shown in broken lines. FIG. 2B illustrates a filter element 215 present in the loader 210. FIG. 2C illustrates an end view of a portion of the loader 210 shown in FIGS. 2A and 2B.

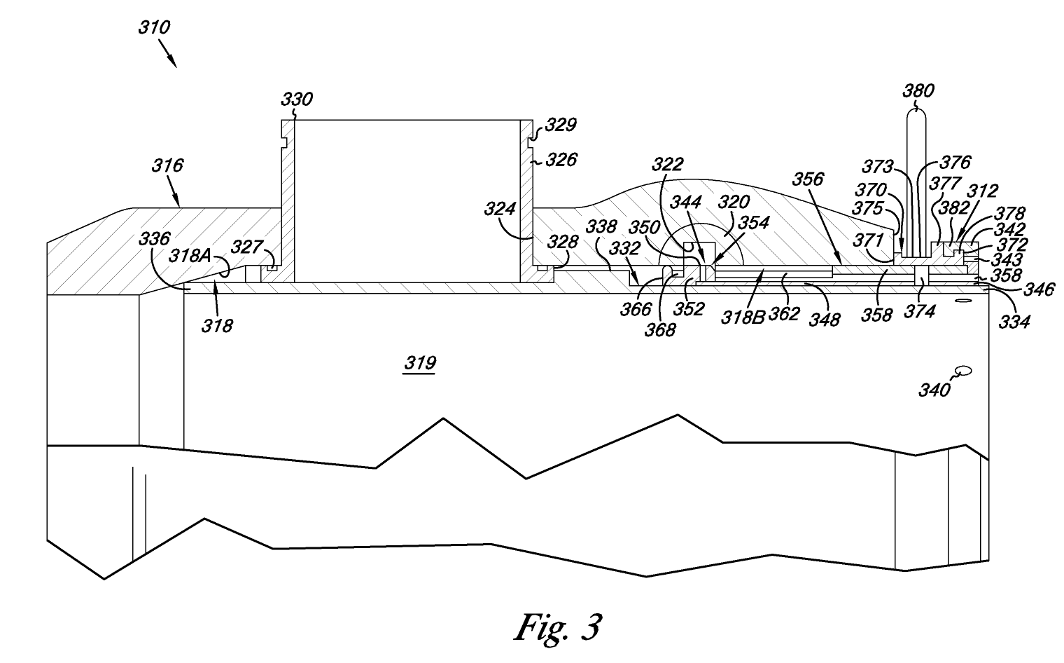

FIG. 3 provides a cross-sectional schematic illustration inside 319 of a pressure vessel 316 as a generally cylindrical hollow space that includes an annularly expanded or flare segment 318. Flare segment 318 includes a hollow truncated conical section 318A and a longitudinal tubular section 318B. Truncated conical section 318A has two openings, one of which has a smaller diameter than the other. In FIG. 3, the smaller diameter opening lies left of the other opening. The other or larger diameter opening accommodates a portion of connection section 312 as described herein.

While pressure vessels, e.g. pressure vessel 316, typically comprise a fiberglass material, other materials of construction may substitute for fiberglass material. An annular, metallic, insert 320 disposed intermediate between section 318A and opening 123 (shown in FIG. 1) has defined therein a recess or groove, e.g., an annular recess or groove, 322. Groove 322 accommodates at least a portion of groove engaging surface 354 of a clamping element 350 in order to securely, but removably, attach and locate connection section 312 within inside 319 of pressure vessel 316. If desired, groove 322 may also or alternatively accommodate an annular snap ring (not shown) to secure a pressure vessel end plate (not shown) during normal operation of a pressure vessel, e.g., with at least one filter element (215 in FIG. 2B) in place.

As shown in FIG. 3, pressure vessel 316 also includes an aperture 324 through a sidewall thereof. Aperture 324 accommodates, at least by way of a friction fit, an inlet/outlet port 326. Inlet/outlet port 326 comprises a cylindrical conduit, one end of which a portion extends into inside 319 of pressure vessel 316 proximate to the larger diameter opening, and distant from the smaller diameter opening of hollow truncated conical section 318A and terminates in an annular flange 328 that is in sealing contact with an inner surface portion of longitudinal tubular section 318B. An outer edge of annular flange 328 constitutes a shoulder that assists in positioning and securing loader 310 relative to pressure vessel 316. An upper surface of annular flange 328 has defined therein an annular recess 327 that accommodates a sealing means such as a gasket or o-ring (not shown) to assist in effecting sealing contact between annular flange 328 and the inner surface portion of longitudinal tubular section 318B. Inlet/outlet port 326 comprises a second, non-flanged end 330. Proximate to second end 330, inlet/outlet port 326 includes an external, circumferential recess 329 that accommodates a sealing means such as a gasket or o-ring (not shown) as an aid in effecting a sealed connection with a second pressure vessel 316 (not shown). Although FIG. 3 shows only one inlet/outlet port, one may use a plurality (two or more) inlet/outlet ports 326 in any pressure vessel 316.

FIGS. 2A, 2B and 3 show that connection section 212/312 of loader 210/310 includes a cylindrical component 232/332. FIG. 3 illustrates that cylindrical component 332 extends from a first, or pressure vessel insert, end 336 and a second, or loader connect, end 334. FIGS. 2A and 2B illustrate that a substantial portion of cylindrical component 232 may be inserted into a pressure vessel 216 such that first end (336 in FIG. 3) is in annular contact with an inner surface portion of hollow truncated conical section 318A. At least a longitudinal portion of loader connect end 334 extends outside pressure vessel 316 to effect connection with section interconnect end or front plate (290 in FIG. 2B) of loader 310 as explained in greater detail below.

Cylindrical component 332 includes an external, annular flange 338 (238 in FIG. 2B) that lies intermediate between first end 336 and second end 334 of component 332. When first end 336 annularly contacts an inner surface portion of conical section 318A, a side portion of flange 338 contacts a side portion of flange 328 of an inlet/outlet 326, thereby effectively orienting component 332 stopping first end 336 from extending further into pressure vessel 316 and away from opening (123 in FIG. 1) of pressure vessel 316. When a pressure vessel 316 includes two or more inlet/outlet ports 326, the side portion of flange 338 is in simultaneous and operative contact with a side portion of each flange 328.

FIG. 3 shows two of a plurality of circumferentially, and in some embodiments equally spaced relative to one another, mounting apertures 340 proximate to, and equidistant from, second end 334 of cylindrical component 332. The mounting apertures 340 are used to secure the inner cylinder 332 of loader 310 with a retaining ring 342. As shown in FIG. 3 connection section 312 also includes a clamping structure 344.

FIG. 4 provides another illustration of clamping structure 444 (344 in FIG. 3). Clamping structure 444 comprises a ring or hoop 446 (346 in FIG. 3) and a plurality (e.g. any of three through twelve) of circumferentially, and in some embodiments equally, spaced fingers 448 (348 in FIG. 3), each of which has a connecting end 447 fastened to a circumferential portion of ring 446 and a distal end 449 that is remote from connecting end 447. Each distal end 449 terminates in an outward facing clamping element 450 (350 in FIG. 3). Each clamping element 450 is a solid, shaped body defined by at least a planar finger contact surface 451, a ramped or beveled surface 452, a groove engaging surface 454 (354 in FIG. 3) and a finger end stop surface 455. In practice, planar finger contact surface 451 connects at one end to finger end stop surface 455 and surfaces 451 and 455 cooperate to provide a uniform location for each clamping element 450 relative to each finger 446 and allow a portion of clamping element 450 to extend beyond each distal end 449. Continuing around clamping element 450, ramped surface 452 (352 in FIG. 3) connects with an end of finger stop surface 455 remote from where surfaces 451 and 455 connect and groove engaging surface 454 extends from an end of ramped surface 452 that is remote from where surfaces 452 and 455 connect or intersect to an end of surface 451 remote from where surfaces 451 and 455 connect. Ring 446 has an axis and fingers 448 extend outward from ring 446 and generally parallel to the axis of ring 446. Groove engaging surface 454 projects radially outward from distal end 449 and generally normal to the axis of ring 446. A plurality of fastening means 453 secure each clamping element 450 to a finger 448 such that a portion of element 450 extends beyond distal end 449 of said finger 448. Fastening means 459 secure connecting end 447 of each finger 448 to ring 446, to an inner surface portion of ring 446. Fastening means 459 used to secure finger 448 to ring 446 and clamping element 450 to distal end 449 of finger 448 may be any one or more of pins, screws, rivets, dowel pins or other mechanical fasteners. As an alternative to, or in conjunction with, a mechanical fastener, one may weld or adhesively bond at least one of finger 448 to ring 446 or clamping element 450 to distal end 449 of finger 448.

Each finger 448 has sufficient flexibility to allow at least distal end 449 and its associated clamping element 450 to flex or move from an initial unflexed, neutral, position radially outward, or away, from the axis of ring 446 and back again in response to, respectively, application of external or motive force and release of said force. In accord with FIG. 3, application of such a force moves at least a portion of at least one clamping element 450, in some embodiments all clamping elements 450, into engagement with annular groove (322 in FIG. 3) and release of such force moves said portion of clamping element(s) 450 away from, and out of engagement with annular groove (322 in FIG. 3). Fabricating fingers 448 from a material such as spring steel imparts sufficient flexibility.

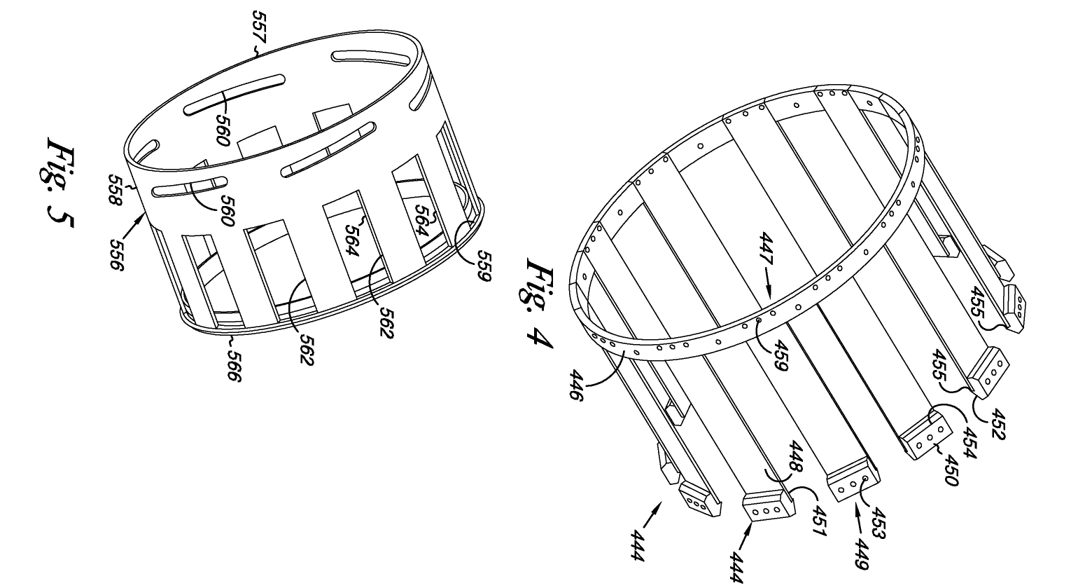

As shown in FIG. 5 connection section (312 in FIGS. 3 and 212 in FIGS. 2A and 2B) further includes a draw ring 556. Draw ring 556 comprises an annular base 558 with a first end 557 and a second end 559 that is radially remote from first end 557, and an annular cam ring 566 that is operatively connected (e.g. fastened, adhered, welded or otherwise secured) to second end 559 of annular base 558. Annular base 558 has defined therein a plurality of elongated apertures or slots (preferably helical) 560 proximate to first end 557. Annular base 558 also has defined therein a plurality (e.g., equal to the number of fingers 448 in FIG. 4) of slots 564, in some embodiments rectangular, open-ended and equally spaced one from another, that extend from a point intermediate between slots 560 and second end 559 to second end 559. Portions of annular base 558 that lie between slots 560 constitute connection segments 562 that terminate at second end 559 in an operative connection with annular cam ring 566 (366 in FIG. 3). Annular cam ring 566 has an interior annular beveled surface, e.g., 368 as shown in FIG. 3.

Although not shown in combination, draw ring 556 of FIG. 5 and clamping structure 444 of FIG. 4 form an operative combination when first end 557 of annular base 558 slides over at least distal ends 449 of fingers 448 of clamping structure 444 to such an extent that each distal end 449 and its associated clamping element 450 lies in longitudinally slidable engagement with an opening 564 of annular base 558. Each slot 560 functions as a cam surface that interacts with a pin or projection, e.g., 374 in FIG. 3, to effect axial or longitudinal movement of draw ring 556 relative to cylindrical component, e.g., 332 in FIG. 3, and clamping structure, e.g., 444 in FIG. 4. Axial movement of draw ring 556 relative to clamping structure 444 such that annular cam ring 566 of draw ring 556 moves toward connecting end 447 of clamping structure 444 effectively causes ramped surface 452 of clamping element 450 to initially contact annular beveled surface (shown as 368 in FIG. 3) of cam ring 566 and, with further axial movement, ride onto, possibly over, annular cam ring 566 thereby flexing at least distal ends 449 and associated clamping elements 450 radially outward from the axis of ring 446. Reversing direction of movement of draw ring 556 relative to clamping structure 444 causes distal ends 449 to slide back over annular cam ring 566 and annular beveled surface (shown as 368 in FIG. 3) into openings 564.

In FIG. 3, axial movement of draw ring 556 toward second end 334 of cylindrical component 332 causes ramped surface 452 of a clamping element 450 to contact and slide over annular beveled surface 368 of annular cam ring 566 thereby forcing at least a portion of groove engaging surface 454 outward, e.g., upward in FIG. 3, into locking engagement with annular groove 322, otherwise referred to as a “locked position”. Reversing axial movement of draw ring 556 such that it moves away from second end 334 effectively causes groove engaging surface 454 to move inward, e.g., downward in FIG. 3, out of locking engagement with annular groove 322, otherwise referred to as an “unlocked position”.

Referring again to FIG. 3, connection section 312 further comprises an operative combination of an annular drive ring 370, a handle 380, pins through a surface 374 and retaining ring 342. Drive ring 370, in some embodiments is an integral, single piece structure, has a first end 371 that physically contacts first end 312 of pressure vessel 316, a second end 372 that is remote from first end 371, a profiled external surface 373 that intersects with both first end 371 and second end 372, and an inner, smooth and hollow cylindrical, surface 374 that intersects both first end 371 and second end 372 and is spaced apart from external surface 373. Proceeding from first end 371 toward second end 372, profiled external surface has, in sequence, a first annular flange segment 375, a first annular recess segment 376, a second annular flange segment 377, a second annular recess segment 379, and a third annular flange segment 378. Handle 380, operatively connected to drive ring 370, e.g., between first annular flange segment 375 and second annular flange segment 377, projects outward from drive ring 370. Handle 380 imparts rotary motion to drive ring 370 as described below. A plurality, e.g., equal in number to helical slots 560 in draw ring 556, of extended finger members 448 extend radially inward from inner surface 373 of ring 370 so as to be in slidable engagement with said helical slots 560.

Retaining ring 342 comprises an assembly of at least two, in some embodiments at least three and in some embodiments at least four, accurate or ring segments that, when taken together form a complete ring. Retaining ring 342 has a smooth outer surface and, radially inward from the outer surface, a shaped, e.g., machined, inner surface that includes, moving seamlessly from left to right in FIG. 3, a flange segment 382, a recess segment and a body segment. Flange segment 382 and recess segment fit, respectively, into second recess 378 of drive ring 370 of drive ring 370 with a sufficiently close fit, e.g., with actual physical contact, so as to preclude movement of drive ring 370 longitudinally with respect to cylindrical component 332 of connection section 312.

Retaining ring 342 also has defined therein a plurality of apertures 343. Each aperture 343 accommodates a suitable fastener that assists in removably securing an end of connection section 312 to an end of loader section, e.g., 214 in FIGS. 2A and 2B. In some embodiments each aperture 343 includes an internally screw threaded segment so as to accept and mechanically engage with threads of an externally screw threaded fastener. FIG. 2A shows a plurality of aperture/fastener combinations 245 of which the fastener portions 245 can be in threadable engagement with corresponding apertures 343. While screw threaded fasteners are described in connection with this example embodiment, other fasteners that provide a substantially equivalent removable connection may be used in conjunction with, or in place of, screw threaded fasteners without departing from embodiments of the present disclosure.

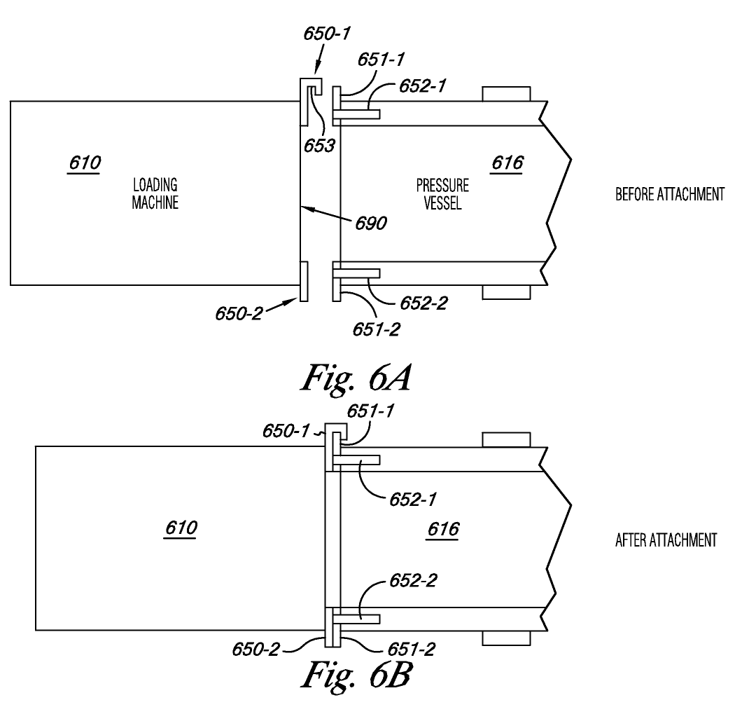

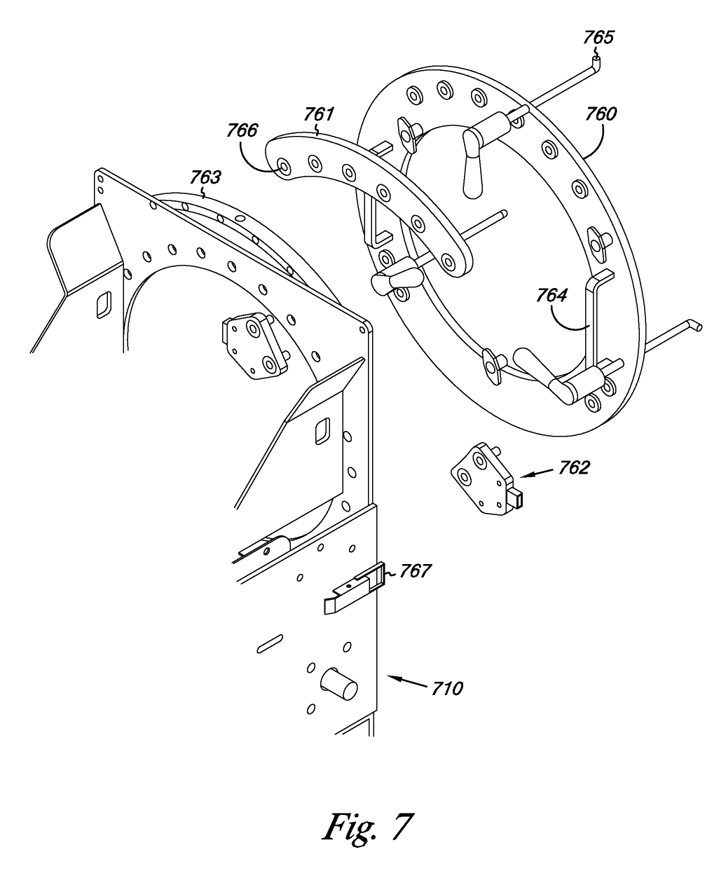

Connection section 312, of the embodiment of FIG. 3, represents an embodiment for the construction for connection section 312. Other constructions may be used for connection section 312, e.g., as described in FIGS. 6A-6B and FIG. 7, provided such constructions both establish an orientation, e.g., a coaxial orientation, between loader 310 and a pressure vessel 316 and maintain, e.g., removably maintain, said orientation long enough to effect element loading or element unloading operations, whichever may be desired. One such other construction involves a modification of section interconnect end or front plate, e.g., 290 of FIGS. 2A and 2B, of loader section 214 shown in FIGS. 2A and 2B so that the front plate overlaps with pressure vessel support structure, e.g., 117 of FIG. 1, frame members on either side of a pressure vessel 116 in FIG. 1 and includes a means to removably secure front plate, e.g., 290 in FIGS. 2A and 2B, and, by extension, all of loader 210 to support structure in alignment with a desired pressure vessel 216.

One such means is a plurality of apertures that coaxially align with internally screw-threaded apertures in frame members of pressure vessel support structure 117 in FIG. 1, at least one of said coaxially aligned apertures on either side of a pressure vessel 116 being secured together by way of an externally screw-threaded fastener such as a screw or machine bolt. Alternately, lifting hooks, such as lifting hooks 204 in FIGS. 2A and 2B, may be used in place of, or in conjunction with, such coaxially aligned apertures in combination with a fastener such as an externally screw-threaded screw or machine bolt. Such lifting hooks engage lifting hook receiving portions (e.g. projecting rods or shaped recesses that support weight of loader 210 on pressure vessel support structure 117 and maintain loader 210 in a desired position relative to a pressure vessel into which one places, or from which one removes, a filter element. As an additional or supplemental alternative, clamps (not shown) such as C-clamps may be used to releasably fix a modified section interconnect end or front plate 290 to upright members of support structure 117. Other variations may also be used without departing from embodiments of the present disclosure.

FIGS. 6A, 6B and 7 illustrate an alternative embodiment in which section interconnect end or front plate 690 of loader 610 includes a pair of laterally extending wing segments, e.g., 650-1 and 650-2 that project from front plate 690 (preferably normal to front plate 690 and disposed away from loader 610 and slidably fit along either side of a pressure vessel 616. In the embodiment of FIGS. 6A and 6B the pressure vessel 616 can include one or more connectors, e.g., 651-1 and 651-2 where at least one connector, e.g., 651-1 and 651-2, connects at least an upper portion 653 of each of the pair of laterally extending wing segments 650-1 and 650-2. As shown in FIGS. 6A and 6B the connectors 651-1 and 651-2 can be attached to the pressure vessel via threaded anchors 652-1 and 652-2. Embodiments, however, are not limited to the threaded anchors 652-1 and 652-2 provided in this example. The laterally extending wing segments 650-1 and 650-2 can engage the connector segments 651-1 and 651-2, extending across and in contact with an upper surface of pressure vessel 616 to effectively place loader 610 in a desired position relative to pressure vessel 616. The desired position allows element loading or unloading as desired.

As yet another variation (not shown), section interconnect plate may have short, relative to those described in the immediately preceding paragraph, lateral wing segments that have defined therein one or more of slots or other projection receiving means that accommodate projections (not shown) on sides of pressure vessel support structure 117 vertical elements or projections that engage slots or other projection receiving means defined in such vertical elements. Skilled artisans can readily envision other variations given this guidance without departing from embodiments of the present disclosure.

FIG. 7 illustrates additional detail for an embodiment for attaching a loader 710 to a pressure vessel (not shown) using an external face mount approach. As shown in FIG. 7 a circular jig plate 760 is provided along with an upper flange plate 761, one or more lower flange plates 762, and a flange receptacle 763. In the embodiment shown in FIG. 7 the jig plate 760, shown with handles 764 and toggle clamps with J-bolts for holding jig 760 against a pressure vessel, can be used as a temporary guide for drilling holes into the end face of a pressure vessel such as a fiberglass pressure vessel. The jig plate 760 can then be removed and the upper 761 and lower 762 flange plates attached to the pressure vessel using threaded inserts 766, such as the commercially available Helicoil™ or Keensert™ inserts, into the fiberglass. In this embodiment, the flange receptacle 763 on the loader 710 hooks over the upper flange 761. The flange receptacle 763 holds the weight of the loader 710 and restrains the loader 710 axially when elements are pushed into the pressure vessel. Latches 767 at the lower flange 762 locations provide additional axial restraint.

An alternative to drilling holes and inserting anchors is to embed attachment features during fabrication of the pressure vessel. A steel ring with threaded holes or a protruding flange, for example, could be integrally wound during pressure vessel fabrication. A steel pressure vessel could also be readily equipped with the necessary external attachment features. As the reader will appreciate, in these alternative embodiments there would be no need for a mechanism, e.g., the connection section 212 in FIGS. 2A and 2B and 312 in FIG. 3, reaching inside the pressure vessel. The loader 710 is brought into proper alignment by gravity and held in place by the latches 767. This approach can be adapted to either bell-mouth or unbelled pressure vessels since no internal clearance is required.

Referring again to FIGS. 2A-2C, loader section 214 comprises a frame 288 and an element transfer mechanism 212 Frame 288 includes, at one end, a front plate 290 that has defined therein a circular opening 292 that is sufficiently large to allow passage therethrough of a filter element (215 in FIG. 2B) and, spaced equidistant around, yet away from, said circular opening 292, aperture/fastener pairs 245. As mentioned above, a plurality of aperture/fastener combinations 245 are provided by which the fastener portions 245 can be in threadable engagement with corresponding apertures, e.g., 343 shown in FIG. 3. Although shown in the embodiments of FIGS. 2A and 2B for assembling loader section 214 and connection section 212, such aperture/fastener pairs 245 may be replaced by other temporary means such as clamps or by a more permanent means such as welding.

Spaced apart from, generally parallel to, and opposite front plate 290, frame 288 includes a rear plate 298. A plurality of side braces 296, e.g., two on each side, one being an upper side brace 296-1 and one being a lower side brace 296-2 aligned normal to, and attached to, said front plate 290 and rear plate 298 cooperate with front plate 290 and rear plate 298 to form an open, e.g., rectangular, outer structure for frame 288. One or more cross braces 201, connect a lower side brace 296-2 on one side with a lower side brace 296-2 on a second side to enhance frame 288 stability. In various embodiments frame 88 includes at least one side plate 297 on each side to connect upper side brace 296-1 to lower side brace 296-2 and further enhance frame 288 stability. FIG. 2 places side plate 297 proximate to front plate 290, but any other placement may be used as long as it does not interfere with loader operations.

Frame 288 also includes a pair of side gussets 202 that extend from rear plate 298 partway toward front plate 290 and, via an operative connection, interconnect an upper side brace 296-1 with a lower side brace 296-2 on a side of frame 288. Side gussets 202 have an operative connection with an intermediate plate 204 that is spaced away from rear plate 298, but situated closer to rear plate 298 than to front plate 290, to form a rectangular, open four sided box. Intermediate plate 204 has defined therein an arcuate, e.g., semicircular, opening 206 oriented such that when viewed on end, e.g., FIG. 2C, one sees a flat base and an arcuate top.

Loader section 214 also comprises a cradle assembly 208. Cradle assembly 208 comprises a pair of spaced apart, cylindrical rods 210 that extend perpendicular to and between front plate 290 and rear plate 298. In addition, rods 210 have an orientation relative to circular opening 292 such that when a cylindrical filter element (215 in FIG. 2B) sits atop rods 210, the filter element has an axis that is coaxial with circular opening 292's axis. With such an orientation and placement, rods 210 hold the filter element in proper alignment for insertion into a pressure vessel 216 (shown in broken lines in FIG. 2A).

As seen in FIG. 2C loader section 214 further comprises a track assembly 212 which serves as part of the element transfer mechanism. Track assembly 212 extends from front plate 290 to rear plate 298 and lies below and substantially parallel to rods 210 in order to avoid movement of a filter element (215 in FIG. 2B) longitudinally along rods 210. Track assembly 212 comprises support brace 219 that has an upper surface which track member 221 lies upon, and is operatively connected by way of fasteners (not shown), to upper surface of support brace 219. Track member 221 includes a pair of shoulders 218 spaced above upper surface and facing away from one another.

A filter element carriage assembly 220, which serves as part of the element transfer mechanism, rides on track member 221, shuttling between rear plate 298 and front plate 290. Carriage assembly 220 comprises a carriage back plate 222, in some embodiments shaped as a half octagon, and oriented with angled sides sloping toward track assembly 212. Carriage back plate 222 has at least one carriage support brace 224 affixed thereto and oriented to face toward rear plate 290. Assembly 220 further comprises a filter element end support bracket connected proximate to edges of carriage back plate 222 other than that edge most remote from track assembly 212 and oriented to project toward front plate 290 and away from rear plate 298. As seen in FIG. 2C bracket preferably comprises a shaped, single piece construction with four side walls 223 and a floor 225. Carriage back plate 222 preferably has defined therein two apertures 226 proximate to floor 225 of bracket and track assembly 212. Rods 210, shown in FIG. 2A, pass through apertures 226, a combination that helps guide filter element carriage assembly 220 as it shuttles back and forth along track assembly 212 within frame 288.

FIG. 2C shows that filter element carriage assembly 220 also comprises a track-engaging structure 228 located on an underside of floor 225 of bracket. Track-engaging portion 228 preferably provides a partial enclosure of track member 221, especially of the pair of shoulders 218.

While one may manually move a combination of filter element carriage assembly 220 and a filter element (not shown) along track assembly 212, a desire for a degree of automation in combination with a move toward improved ergonomics suggests use of a drive mechanism. FIGS. 2A-2C illustrates a preferred drive mechanism or drive assembly 230 that comprises, in part, a motor 232, e.g., a reversible (can be driven in either direction) drive motor such as an electric, reversible drive motor. Motor 232 preferably responds to selective energizing signals from a control means (not shown). Limit switches (not shown) suitably send signals to such control means to, as needed, disengage, idle or halt motor revolution or reverse motor drive direction.

Drive assembly 230 also preferably comprises a gear box 234, shown in FIG. 2C, operatively connected to motor 232 by way of a motor drive shaft (not shown). In various embodiments the gear box has an 80-to-1 ratio, but other ratios and gear boxes may be used without departing from embodiments of the present disclosure as long as gear box 234 and motor 232 combine to provide sufficient motive force to cycle loader 210 through loading or unloading of at least one, preferably several, filter elements (215 in FIG. 2B).

FIGS. 2A and 2C, show that an output shaft 236 extends from both sides of gear box 234 through side plate 297 on either side of loader 210 and into a bushing 238 mounted on an outer surface of each side plate 297. The bushings 238 allow rotational movement of shaft 236 about a fixed axis. Proximate to, but spaced apart from, an inner side of each side plate 297, output shaft 236 includes a lower drive pulley, e.g., a toothed drive pulley 242. A channel or “C” shape for upper side brace 296 is modified by removing a portion of one of two sides or flanges to accommodate drive assembly components. In various embodiments, drive assembly 230 includes three pulleys, a front pulley 244, a tensioning pulley 248, and a rear pulley 246, on each side of frame 288 in addition to toothed drive pulley 242 as well as a drive belt, e.g., a toothed drive belt, 240. FIGS. 2A and 2C show placement of front pulley 244 above and closer to front panel 290 than lower drive pulley 242. Tensioning pulley 248 lies vertically intermediate between front pulley 244 and drive pulley 242 and spaced further away from front panel 290 than front pulley 244. Front pulley 244 operatively connects to frame 288 proximate to, but spaced away from, front panel 290, preferably in that portion of upper side brace 296 from which a flange portion has been removed. Tensioning pulley 248 operatively connects to side plate 297 of frame 288. A pulley securing plate 237 (seen in FIG. 2C) maintains placement of a freely rolling front pulley 244 on frame 288 and allows rotation and limited lateral movement of tensioning pulley 248. Rear pulley 246 preferably has an operative connection to upper side brace 296 proximate to rear plate 298 and remote from both front pulley 244 and front plate 290. Drive belt 240 has an inner, preferably toothed side, that engages the teeth of drive pulley 242 and inner, belt contact surfaces of front pulley 244 and rear pulley 246, and an outer, flat or smooth side that rides against belt contact surface of tensioning pulley 248. In other words, drive belt 240 forms a continuous path around drive pulley 242, front pulley 244 and rear pulley 246, with tensioning pulley 248 applying sufficient force against drive belt 240 to maintain contact between the inner surface of drive belt 240 and the best receiving surfaces of each of pulleys 242, 244 and 246. Interaction of toothed belt 240 with toothed portions of drive pulley 242 effectively transmit motive force from output shaft 236 to the drive belt 240 and thence to carriage assembly 220.

Carriage assembly 220 preferably includes at least one clamping structure 251 (FIG. 2C) that secures carriage back plate 222 to a drive belt 240. Each drive belt 240 has a clamping structure 251 that connects a different portion of back plate 222 to a drive belt 240. FIG. 2C illustrates two clamping structures 251, each of which comprises a pair of opposed flanges 252 that project outward from side walls 223 of carriage assembly 220 toward an upper side brace 296 of frame 288. At least one of the opposed flanges 252 preferably contains a plurality of teeth that engage the toothed side of drive belt 240. By disposing a drive belt 240 between a pair of opposed flanges 252 and applying sufficient compressive force from one flange 252 toward the other flange 252, the pair of flanges 252 effectively secure or clamp drive belt 240 to a certain location on the belt 240.

As carriage assembly 220 moves along track member 221 of track assembly 212 from a position proximate to rear plate 298 toward front plate 290, carriage assembly 220 facilitates pushing or loading a filter element (215 in FIG. 2B) at least part way, preferably completely, into pressure vessel 216 via opening 292 (seen in FIG. 2A). Reversing carriage assembly 220 movement direction and proceeding from a position proximate to front plate 290 toward rear plate 298 effects pulling or removing a filter element 215 at least part way, preferably completely, from pressure vessel 216.

While loader 210 may be used to simply push elements 215 into pressure vessel 216 and establish, possibly by way of a tubular interconnect (not shown) proximate ends of two elements, operative contact between adjacent elements, loader 210 preferably includes a capability of rotating one element 215-1 relative to an adjacent second element 215-2 (seen in FIG. 2B), especially when such elements each have endcaps 253 that interlock one with another via rotary motion, either to establish, or to break, an interlock between endcaps of proximate element ends. U.S. Pat. No. 6,632,356, the teachings of which are incorporated herein by reference, illustrates such endcaps.

FIGS. 2A and 2B shows an embodiment of carriage assembly 220 that includes a rear end plate assembly 256. Rear end plate assembly 256 includes a filter end cap engaging structure (not shown) that removably attaches to a filter end cap to assist element loading and unloading operations, especially those that include rotatably locking adjacent filter elements to each other or unlocking adjacent filter elements from each other. A thrust bearing 258 or other suitable connection means, preferably rated for both compression and tension, attaches rear end plate assembly 256 to carriage back plate 222 by way of handle plate 260 (seen in FIG. 2B). Thrust bearing 258 allows handle plate 260 to rotate in place relative to carriage assembly 220, preferably in response to motive force applied to handle 261 that is secured to handle plate 260 on a side opposite the filter end cap engaging structure (not shown).

Loader 210 preferably further includes at least one locking mechanism 205 as part of loader section 214 proximate to front plate 290. Locking mechanism 205 engages a portion of a element, e.g., 215-2 in FIG. 2B, to hold it in place while a second element, e.g., 215-1 in FIG. 2B located adjacent the element held in place and between front plate 290 and rear plate 298 moves, preferably rotatably, relative to the element held in place during operations to connect end caps to, or disconnect end caps from, each other. FIGS. 2A-2C show attachment of locking mechanism 205 to an outer surface portion of wall section 203. At least a portion wall section 203 preferably attaches normal to a face of front plate 290 that faces toward rear plate 298 proximate to, but not extending into, a side of opening 292. More preferably, a locking mechanism 205 attaches to each of two wall sections 203, one at each of a three o'clock position and a nine o'clock position when viewing opening 292 from rear plate 298 to that track member 221 is at a six o'clock position. An extendable and retractable projecting section 207 preferably with a rubber cap on its tip, aligns with an opening of wall section 203. When extended through opening, projecting section 207 engages an end cap (not shown) of an element 215 and holds said element in place during connection and disconnection operations. When retracted or not extended through opening, section 207 does not impede any motion, either axial or rotary, of an element or any portion of an element (e.g. an end cap).

Loader 210 optionally further comprises a plurality of lifting hooks 204. FIGS. 2A and 2B shows a combination of two spaced-apart lifting hooks 204 operatively connected or secured proximate to an upper edge portion of each of front plate 290 and intermediate plate 294. If desired, a lifting device (not shown) engages lifting hooks 204 to roughly position loader 210 relative to a pressure vessel 216.

In one operational embodiment discussed in reference to FIG. 3, establishing an operative connection between connection section 312 and pressure vessel 316 preferably involves several steps. First, roughly position and orient connection section 312 relative to pressure vessel 316, particularly relative to opening (e.g., 123 in FIG. 1) of pressure vessel 316, by inserting inner cylinder 332 into flare 318 of pressure vessel 316 until raised flange 338 engages shoulder 328 inside pressure vessel 316. Second, use handle 380 to rotate drive ring 370 by an amount sufficient to cause pins 374 to interact with helical slots (560 in FIG. 5) and cause draw ring (556 in FIG. 5) to move axially with respect to inner cylinder 332 and toward loader connect end 334. As draw ring (556 in FIG. 5) moves, annular beveled surface 368 of cam ring 366 engages ramped surface 352 of clamping element 350, thereby causing fingers 348 (448 in FIG. 4) to flex outwardly until groove engaging surface 354 of clamping element 350 moves into operative engagement with groove 322 inside pressure vessel 316, preferably by way of physical contact between at least portions of groove engaging surface 354 and surfaces of groove 322, to lock or secure positioning of connection section 312 to, and within, pressure vessel 316 (also known as “locked position”). In the locked position, loader 310 may be used to load or unload filter elements (215 in FIG. 2B) respectively into or from pressure vessel 316

In order to remove loader 310 from a pressure vessel 316, simply reverse procedures outlined in the immediately preceding paragraph. In particular, use handle 380 to rotate drive ring 370 in a direction opposite that used to establish the locked position, thereby causing pins 374 to interact with helical slots (560 in FIG. 5) and cause draw ring (556 in FIG. 5) to move away from loader connect end 334. As draw ring (556 in FIG. 5) moves away from loader connect end 334, annular beveled surface 368 of cam ring 366 disengages from ramped surface 352 of clamping element 350, thereby allowing fingers 348 (448 in FIG. 4) to relax toward a preferably neutral position and moving groove engaging surface 354 out of operative engagement with groove 322 into a position that allows one to remove loader 310 (otherwise known as “unlocked position”).

Referring to FIGS. 2A-2C, once loader 210 is in the locked position, filter elements 215 can be loaded into, or unloaded from, pressure vessel 216. In an initial step, establish a connection between the element end cap engaging structure of rear end plate assembly 256 and an end cap 253 of an element 215 to be loaded or unloaded, the end cap facing toward rear plate 298 of loader section 212. For insertion, a filter element 215 is placed in the cradle assembly 208 and more specifically, on rods 210. The motor 232 is energized to cause the rear end plate assembly 256 to move to a first predetermined location. This predetermined location is determined by reference to the handle plate 260. That is, the handle plate 260 is brought to the same location with respect to the frame 288. A limit switch (not shown), operatively coupled with the motor 232, is set at this location.

As seen in FIGS. 2A and 2B as the rear end plate assembly 256 moves toward the filter element 215, a spring (not shown) located between the rotatable ring 276 and handle plate 260 is in an unloaded condition. That is, the spring is neither in compression nor tension. In this state, the outer ring 262 is spaced from the handle plate 260. As the rear end plate assembly 256 moves to the first predetermined location, the rear end plate assembly 256 is adapted to allow an operator to know whether an engaging ring, i.e., rotatable ring 276, contacts the end cap 253 of the filter element 215 or whether an engaging element is engaging the spokes 254 of the filter element 215. More specifically, if the engaging element engages the spokes 254 of the filter element 215, then the rear end plate assembly 256 is in an improper orientation to insert or remove the filter element 215 from the pressure vessel 216. This improper orientation, having the engaging elements contacting the spokes, 254 can be seen by an operator. In the proper orientation, the engaging elements are between adjacent of the spokes 254 and the engaging ring engages the end cap 253. Further the fingers of the engaging element move past the spokes 254.

As seen in FIGS. 2A and 2B fastener locations 266 are provided to connect the rotatable ring 276 to the handle plate 260. If the engaging element contacts the spokes 254 as the motor 232 moves the rear end plate assembly 256 to the first predetermined location, the spring between the rotatable ring 276 and handle plate 260 will compress or become loaded and the rotatable engaging ring 276 will move closer to the handle plate 260. Accordingly, an operator will know that the rear end plate assembly 256 is in an improper orientation for inserting the filter element 215. To be in the proper orientation, the engaging elements must be moved off of the spokes 254 to a position between adjacent of the spokes 254. Further, the engaging ring 276 moves to engage the outer surface of the end cap 253.

When the engaging element contacts a filter element spoke 254 and the rear end plate assembly 256 is in the improper orientation, the handle plate 260 and thus, the entire rear end plate assembly 256 is manually rotated about the thrust bearing 258 by moving the handle 261. Movement of the handle 261 causes the entire rear end plate 256 assembly to rotate. The rear end plate assembly 256 is rotated until the spring between the rotatable engaging ring 276 and handle plate 260 unloads and the engaging ring 276 is in the proper orientation.

A visual indication will allow an operator to know whether the engaging element is moved off the spoke and the engaging ring 276 moves to contact with the end cap 253 of filter element 215. More specifically, as the rear end plate assembly 256 rotates, and the engaging element moves past the spoke of the filter element 215, the spring unloads. The spring acts against the handle plate 260 that is retained in the axial direction and causes the rotatable engaging ring 276 to move toward the filter element 215 until the engaging ring 276 contacts the end cap 253 of the filter element 215. This unloading of the spring can be seen by an operator because a space between the handle plate 260 and the outer ring 262 will be restored.

When in this proper position, a cylindrical portion of engaging element is located between adjacent of the spokes 254 and the engaging ring 276 contacts the end cap 253. Once in this position, the filter element 215 is aligned with respect to the rear end plate assembly 256. The motor 232 can then be energized causing the carriage assembly 220 to move forwardly to a second predetermined location to load the filter element 215 into the pressure vessel 216. As seen by the position of element 215-1 in FIG. 2B, the second predetermined location of the rear end plate assembly 256 is located within the loader section 214 and spaced from the front plate 290. In this second predetermined position of the rear end plate assembly 256, the filter element 215-1 is only partially disposed within the pressure vessel 216. This is important only when adjacent filter elements 215 need to be secured together by imparting relative rotation therebetween.

Once a first filter element 215-1 is loaded into the pressure vessel 216, the motor 232 can be reversed thus moving the rear end plate assembly 256 back to its original position to receive another filter element 215-2. A second filter element 215-2 can then be loaded. To do this, the locking mechanism 205 is actuated to engage the rubber tip 207 with the end cap 253 of the first filter element 215-1. This will prevent both rotational and longitudinal movement of the first element 215-1 while a second filter element 215-2 is being connected to the first filter element 215-1. The second filter element 215-2 is placed on the cradle assembly 208 and the motor 232 is energized causing the rear end plate assembly 256 to move to the first predetermined position. The above process is then repeated to ensure proper orientation of the rear end plate assembly 256 with respect to the next filter element 215. As set forth above, in the event that the rear end plate assembly 256 is in the improper orientation, the handle 261 is rotated until the rear end plate assembly 256 is in the proper orientation.

In the case of securing a second filter element 215-2 to a first filter element 215-1 already loaded in the pressure vessel 216, the rear end plate assembly 256 urges the end cap 253 of the second filter element 215-2 into engagement with the end cap 253 of the first filter element 215-1. This is done under the force of the spring between the rotatable ring 276 and handle plate 260. More specifically, when the handle plate 260 is in the first predetermined position, the spring fully unloads and fully urges the engaging ring 276 forwardly, then, in addition to the rear end plate assembly 256 being in the proper orientation, the second filter element 215-2 will also be in a proper orientation. It will be appreciated that the end caps 253 have interlocking features as is well-known. The interlocking features must be rotated so that they are properly aligned so that the second filter element 215-2 can be placed immediately adjacent the first filter element 215-1. Once the interlocking features of the end caps 253 are properly aligned, the springs will force the engaging element to a proper orientation maintaining the first filter element 215-1 and second filter element 215-2 in an alignment that allows adjacent end caps 253 to be locked. The handle 261 is then rotated causing rotation of the end cap 253. The handle 261 continues to be rotated until the locking features of the adjacent end caps 253 of adjacent filter elements 215 are secured. An audible or visual feedback will be provided to let the operator know that the first and second filter elements 215 are secured.

Once the first and second filter elements 215 are secured, the locking mechanism 205 is moved to disengage the rubber tip 207 from the end cap 253 of the first filter element, e.g., 215-1. The motor 232 is energized causing the rear end plate assembly 256 to move to the second predetermined position. As this happens, the first filter element 215-1 is completely moved into the pressure vessel, and the second filter element 215-2 is then partially disposed within the pressure vessel 216.

This process is repeated until the requisite numbers of filter elements 215 are placed into the pressure vessel. In order to ensure that the last filter element 215 is fully inserted into the pressure vessel, a dummy element, e.g., a template or artificial element, (not shown) may be used. The dummy element is used only for purposes of moving the last filter element 215 totally into the pressure vessel 216. For insertion, the dummy element need not lock with the end cap 253 of the last filter element 215 being inserted into the pressure vessel 216. But the dummy element should have an end cap assembly similar to that on each of the filter elements 215. This is so the dummy element can be removed from the pressure vessel 216.

After the last filter element 215 is locked, the dummy element is placed onto the cradle assembly 208 just as a regular filter element. The rear end plate assembly 256 is moved to the first predetermined position as set forth above. The handle 261 is rotated until the engaging elements move past the spokes of the dummy element end cap. Further, the handle 261 is rotated until the cylindrical portion of the engaging element engages a spoke of the dummy element (not shown). Then, the motor 232 is energized and the rear end plate assembly 256 is moved to the second predetermined position. The dummy element is long enough to place the last filter element 215 into the pressure vessel past the annular groove (322 in FIG. 3) that is used to secure the pressure vessel end cap assembly to the pressure vessel 216.

Since the dummy element is not secured to the end cap 253 of the last filter element 215, the dummy element can be removed from the pressure vessel 216 by energizing the motor 232 in the opposite direction to withdraw the dummy element and return the rear end plate assembly 256 to its original position. Because the engaging elements to the rotatable engagement ring 276 grip an annular ring on the dummy element, the dummy element will withdraw under the pulling force of the engaging elements from the pressure vessel 216 and move with the rear end plate assembly 256. In this manner, the dummy element is extracted from the pressure vessel 216. The dummy element can then be removed from the loader section 214. The motor 132 can then be energized again causing it to move rearwardly until the engaging element is clear of the end cap of the dummy element. Then the dummy element can be lifted off of the rods 210 and out of the loader section 214.

Referring to FIG. 3, after the last filter element has been loaded and the dummy element has been removed, the loader 310 can be disengaged from the pressure vessel 316. This is accomplished by rotating the handle 380 on the drive ring 370. The pin 374 will move in the slot (560 in FIG. 5) causing the draw ring (556 in FIG. 5) to move to the left. The fingers 348 (448 in FIG. 4) will then move to their normally biased position removing the engaging surfaces 354 from contact with the groove 322. This places the loader in the unlocked position. When in this position, the loader 310 can be moved until the inner cylinder 332 is removed from the inside 319 of pressure vessel 316. A suitable hoist mechanism (not shown) may be connected to lifting hooks (204 in FIGS. 2A and 2B) to help position the loader 310 with respect to the next pressure vessel 316 into which filter elements (215 in FIG. 2B) will be loaded or unloaded.

In reference to FIGS. 2A-2C, the loader 210 can be used not only to load filter elements 215 into the pressure vessel 216, but also can be used to unload filter elements 215 from the pressure vessel 216. This is accomplished in a manner similar to that described above for extracting the dummy element from the pressure vessel 216. Specifically, to extract filter elements 215 from the pressure vessel 216, first a dummy element (not shown) must be loaded on the rods 210 of cradle assembly 208. The motor 232 is energized to the first predetermined position and the handle 261 is rotated until the rear end plate assembly 256 is in the proper orientation for inserting a filter element. Next, the handle 261 is rotated until the cylindrical portion of the engaging element is between adjacent spokes 254 of the dummy element. In order to extract or unload a filter element 215 from the pressure vessel 216, the dummy element needs to have a mechanism (not shown) to engage the end cap 253 of the last filter element 215 in the pressure vessel 216. This mechanism can take any form, such as comprising an end cap adapted to engage and mate with the end cap 253 of the filter element 215 in the normal manner. Additionally, the end of the dummy element may simply have a plurality of fingers (not shown), similar to the engaging element operation that can be rotated behind a lip of the end cap 253 of the last filter element 215.

Once the dummy element is loaded and is in the proper orientation, the motor 232 is energized until the dummy element is inserted into the pressure vessel 216 and the dummy element engages the end cap 153. This location is preferably the second predetermined location of the rear end plate assembly 256. A limit switch operatively coupled with the motor 232 stops the motor when the rear end plate assembly 256 has reached this location. The handle 261 is rotated until the dummy element engages the end cap 253 of the last filter element 215 and is secured therewith. When this is complete, the motor 232 is energized causing the dummy element to be extracted and placed in the loader section 214 on the rods 210. The last filter element 215 in the pressure vessel 216 is partially displaced from the inside 219 of the pressure vessel 216. The position of the rear end plate assembly 256 is controlled via control of the motor from a suitable limit switch (not shown) to position the last filter element 215 such that its end cap 253 is adjacent the locking mechanism 205. The locking mechanism 205 is then actuated so that the rubber tip 207 contacts the end cap 253 of the last filter element 215 and prevent movement thereof. The handle 261 is rotated until the dummy element is freed from the end cap 253 of the filter element 215. The motor 232 is then energized causing the rear end plate assembly 256 to move rearwardly until the engaging element is clear of the end cap of the dummy element. The dummy element is then removed from the loader section 214 by lifting it off of the rods 210.

To remove or unload the next filter element 215, the motor 232 is energized until the rear end plate assembly 256 is placed in the second predetermined location and engages the end cap 253 of the filter element 215 that has partially been removed from the pressure vessel 216. Again, this position is controlled by a suitable limit switch (not shown). If the engaging elements contact the spokes 254 on the end cap 253, the spring will compress or load. Again, as set forth above, the visual indications that the spring is compressed or loaded will be provided. In this event, the handle 261 is rotated until the engaging element is clear of the spoke 254. The spring will urge the engaging plate 276 into contact with the end cap 253 of the filter element 215. The engaging elements are moved to engage a lip on the annular ring of the end cap 253.

Once in this position, the locking mechanism 205 is moved so that the rubber tip 207 disengages the end cap 253. The motor 232 is then energized to bring the rear end plate assembly 256 to the first predetermined position. Once in this position, the locking mechanism 205 is again actuated to bring the rubber tip 207 into connection with the end cap 253 of the next adjacent filter element 215. The handle 261 is rotated so that to rotate the end cap 253 of the filter element 215 out of a locked position with the end cap 253 of the next adjacent element 215. A visual or audible reference will be made to allow the operator to know that the adjacent filter elements have been unlocked from one another. Once the adjacent filter elements 215 have been unlocked, the engaging elements are moved clear of the lip on the annular ring on the end cap 253. The motor 232 is energized to move the rear end plate assembly 256 rearwardly until the engaging element is clear of the end cap 253. Once the rear end plate assembly 256 is clear of the end cap 253, the filter element 215 can be removed from the loader. This process is repeated until all of the desired filter elements 215 are removed from the pressure vessel 216.

Because the filter elements 215 are heavier than in the past, it may be desirable to include a structure that aids in placing the filter element 215 on the cradle assembly 208 or removing a filter element 215 therefrom. Such a system may include a lift bar, as will be understood by one of ordinary skill in the art, which may be secured to a suitable lifting device (not shown) located above the pressure vessel 216 to which the filter element 215 is to be inserted or from which it is being removed. Connecting chains may be secured on either end of lifting bar. Suitable end cap engagements may be secured on the end of the chains. As one of ordinary skill in the art will appreciate upon reading this disclosure, the end cap engagements can be adapted to engage a part of the end cap 253, e.g., the spokes 254. End cap engagements can provide a hook that can be placed inside the opening in a spoke 254. Once connected, the lifting mechanism can be actuated to raise or lower the filter element 215 into or out of the loader 210.

The invention has been described in an illustrative manner and it is to be understood that the terminology which has been used is intended to be in the nature of words of description rather than of limitation. Obviously, many modifications and variations of the present invention are possible in light of the above teachings. It is, therefore, to be understood that, within the scope of the appended claims, the invention may be practiced other than as specifically described.

1. A loader for moving a filter element from one to another of a loaded position and an unloaded position, each position being relative to an interior, element-receiving portion of a pressure vessel, the pressure vessel also having an exterior spaced apart from said interior so as to form a pressure vessel body, the pressure vessel body being secured in place by a support structure operatively connected to at least a surface portion of the pressure vessel exterior, the loader comprising:
a loader section and a connection section;
the loader section having a section interconnect end, a distal end remote from the section interconnect end, and an element support structure, the element support structure spanning between, and being operatively connected to, each of the section interconnect and distal ends; and
the connection section having a pressure vessel insert end, a loader connect end, and a connecting guide structure, the connecting guide structure spanning between, and being operatively connected to each of pressure vessel insert end and the loader connect end, the section interconnect end of the loader section, the loader connect end being connected to the section interconnect end of the loader section to provide an assembled loader.

2. The loader of claim 1, wherein the assembled loader includes at least one pressure vessel connecting means, each pressure vessel connecting means being proximate to the operative connection between the loader section and the connection section to coaxially, securely align the assembled loader with the pressure vessel.

3. The loader of claim 1, wherein the loader connect end of the connection section is operative to removably secure the assembled loader to a portion of at least one of a pressure vessel support structure and a pressure vessel.

4. The loader of claim 1, wherein the connection section further comprises a pressure vessel locking mechanism that is operatively connected to an external surface portion of the connection section proximate to its loader connect end and extending toward its pressure vessel insert end.

5. The loader of claim 4, wherein the pressure vessel locking mechanism includes a movable clamping element and the interior, element-receiving portion of the pressure vessel has defined therein a annular groove, the clamping element being located proximate to the annular groove and having a locked position wherein the clamping element is engaged with the annular groove and an unlocked position wherein the clamping element is disengaged from the annular groove.

6. The loader of claim 5, wherein the pressure vessel locking mechanism comprises:
an interactive combination of a draw ring and a clamping structure, the clamping structure comprising;
an annular ring and a plurality of fingers each of which has a connecting end affixed to an annular surface of the annular ring; and
a distal end remote from the connecting end, the distal end terminating in a clamping element; and
the draw ring comprising;
an annular base with a first end and a second end;
the second end being connected to an annular cam ring; and
the draw ring having defined therein a plurality of elongated openings, the clamping structure fitting within the draw ring such that a distal end of each finger fits within a corresponding elongated opening and is axially movable therein such that a surface portion of the distal end interacts with a surface portion of the annular cam ring to flex at least the clamping element outward from said cam ring.

7. The loader of claim 6, wherein said connection section further comprises a drive ring, the drive ring circumscribing a portion of the draw ring proximate to the first end of the draw ring and including a guide pin spaced around an inner surface of the drive ring, the draw ring further comprises a helical guide slot proximate to its first end, and a draw ring guide pin is disposed within, and also movable within, the helical guide slot.

8. The loader of claim 1, wherein the interior, element-receiving portion of the pressure vessel includes a bell-shaped opening, the pressure vessel having a first inner diameter and a second inner diameter, the first inner diameter associated with the bell-shaped opening and larger than the second inner diameter in order to receive the connection section therein.

9. The loader of claim 8, wherein the loader section includes a front plate secured to the connection section and having an opening to allow the filter element to move into and out of said loader section and through the connection section.

10. The loader of claim 1, wherein the loader section further includes a carriage assembly moveable relative to the element support structure and operative to engage the filter element and move it between loaded and unloaded positions.

11. The loader of claim 10 wherein the carriage assembly includes a rear end plate assembly operative to engage the filter element.

12. A pressure vessel loader, comprising:
a cradle assembly to receive a filter element;
a carriage assembly attached to the cradle assembly and to move a position of the filter element relative to the cradle assembly; and
a connection section to coaxially, securely align the pressure vessel loader with a pressure vessel while the carriage assembly moves the filter element to an interior of the pressure vessel.

13. The loader of claim 12, wherein the connection section attaches to a support structure indexed relative to the pressure vessel.

14. The loader of claim 12, wherein the connection section attaches to a pressure vessel support structure supporting the pressure vessel.

15. The loader of claim 12, wherein the connection section attaches to an exterior end of the pressure vessel.

16. The loader of claim 12, wherein the connection section includes a flange receptacle which attaches to a flange plate mounted on the pressure vessel.

17. A method of moving a filter element between loaded and unloaded positions with respect to a pressure vessel that is supported by a support structure, the pressure vessel having an inside surface, an outside surface, and a sealable opening through which a filter element may pass into or out of a space defined by the inside surface, said method comprising:
releasably securing a loader to at least one of the pressure vessel and support structure; and
moving a filter element between a loaded and unloaded position.

18. The method of claim 17, wherein the method includes releasably securing the loader to the inside surface of the pressure vessel.

19. The method of claim 17, wherein the method includes releasably securing the loader by providing a connection section having at least one clamping element and engaging the clamping element with the inside surface of the pressure vessel.

20. The method of claim 17, wherein the method includes moving the filter element between the loaded and unloaded positions by:
providing a motor and a carriage assembly operatively associated with the motor, to receive and securably align the filter element; and
using the motor to move the carriage assembly.

21. The method of claim 20, wherein the method includes loading a first filter element into the pressure vessel by moving the carriage assembly to insert the first filter element at least partially into the pressure vessel.

22. The method of claim 21, wherein the method includes loading a second filter element into the pressure vessel by:
moving the second filter element into contact with the first filter element;
rotating the second filter element with respect to the first filter element to secure the first and second filter elements together; and
using the motor to move the first filter element wholly within the pressure vessel and the second filter element at least partially into the pressure vessel.

23. The method of claim 22, wherein using a locking mechanism on the loader to clamp the first filter element prior to rotating the second filter element.

24. The method of claim 20, wherein the method includes unloading the filter element from the pressure vessel by:
moving the carriage assembly into contact with the filter element;
engaging the carriage assembly with the filter element; and
moving the carriage assembly to remove the filter element from the pressure vessel.

25. The method of claim 24, wherein engaging the carriage assembly with the filter element includes contacting a dummy filter element between the carriage assembly and the filter element to engage the filter element.
